(19) United States
(12) Patent Application Publication
(10) Pub. No.: US 2014/0014488 A1
(43) Pub. Date: Jan. 16, 2014

(54) BACK LIGHTED MEMBRANE KEYBOARD WITH PARTS BEING SECURED TOGETHER BY SUBJECTING TO ULTRASONIC WELDING

(71) Applicant: Huo-Lu Tsai, Taichung City (TW)

(72) Inventor: Huo-Lu Tsai, Taichung City (TW)

(73) Assignee: Sunrex Technology Corp., Taichung City (TW)

(21) Appl. No.: 13/549,403

(22) Filed: Jul. 13, 2012

(51) Int. Cl. H01H 13/76

(52) U.S. Cl. 200/5 A

(57) ABSTRACT

A membrane keyboard is provided with transparent keys each including a bottom key shaft; a key housing including openings for receiving the keys, and downward extending stems; a membrane circuit board below the key housing and including elastic members and a light blocking layer; scissor-shaped structures each including a central opening, two first slide axles, two second slide axles below the first slide axles, a first pivot shaft opposing the first slide axles, and a second pivot shaft opposing the second slide axles and below the first pivot shaft wherein the first slide axles and the first pivot shaft are pivotably secured to the key bottom; a transparent light emitting and guiding plate below and electrically connected to the membrane circuit board; and an aluminum plate below the light emitting and guiding plate and including retaining members for pivotably receiving the second slide axles and the second pivot shaft.

### BACKGROUND OF THE INVENTION

1. Field of the Invention

The invention relates to membrane keyboards and more particularly to a back lighted membrane keyboard having parts being secured together by subjecting to ultrasonic welding.

2. Description of Related Art

Laptops are widely used by people throughout the world due to portability, word processing, and other capabilities common to desktop computers, and Internet access. Membrane keyboards are typically incorporated into laptops. Membrane keyboards are advantageous for being thin, lightweight, and compact. However, most types of laptops are limited to operate in a bright environment since there is no backlight device provided.

For overcoming above drawback, in my earlier U.S. Pat. No. 7,608,792, an improved membrane keyboard/keypad with arrangement for uniformly lighting keys from background is disclosed.

While the U.S. Patent has been successfully used in a commercial application, in practice it is found that parts of the U.S. Patent are not always aligned since they are assembled by adhesive. This adversely lowers the yield. Thus, continuing improvements of membrane keyboards for laptop are constantly sought by the present inventor.

### SUMMARY OF THE INVENTION

It is therefore one object of the invention to provide a membrane keyboard comprising a plurality of transparent keys each comprising a key shaft on a bottom; a plastic key housing comprising a plurality of rectangular openings each for receipt of the key, and a plurality of downward extending stems; a membrane circuit board disposed below the key housing and comprising a plurality of dome-shaped elastic members, a plurality of first openings spaced around the elastic member, a plurality of second openings spaced around the first openings, and a light blocking layer spaced around the first openings; a plurality of scissor-shaped structures each comprising a central opening, two first slide axles, two second slide axles below the first slide axles, a first pivot shaft opposite to the first slide axles, and a second pivot shaft opposite to the second slide axles and below the first pivot shaft wherein the first slide axles and the first pivot shaft of each scissor-shaped structure are pivotably secured to the bottom of the key and the central opening of each scissor-shaped structure is spaced around the elastic member; a transparent light emitting and guiding plate disposed below the membrane circuit board and electrically connected to the membrane circuit board, the light emitting and guiding plate comprising a plurality of first apertures aligned with the first openings, and a plurality of second apertures spaced around the first apertures and aligned with the second openings; and an aluminum plate disposed below the light emitting and guiding plate and comprising a plurality of retaining members, a plurality of bosses spaced around the retaining members, and a plurality of holes each disposed in the boss; wherein the stems are disposed through the second openings, the second apertures, and the holes for positioning; wherein the second slide axles and the second pivot shaft of each scissor-shaped structure are pivotably disposed in and retained by the retaining members; and wherein the positioned stems are subjected to ultrasonic welding to be fastened.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of membrane keyboard for laptop according to the invention;

FIG. 2 is a fragmentary view of FIG. 1 depicting details of a single key construction;

FIG. 3 is a longitudinal sectional view of the assembled parts of FIG. 2; and

FIG. 4 is a detailed view of the area in circle A in FIG. 3.

### DETAILED DESCRIPTION OF THE INVENTION

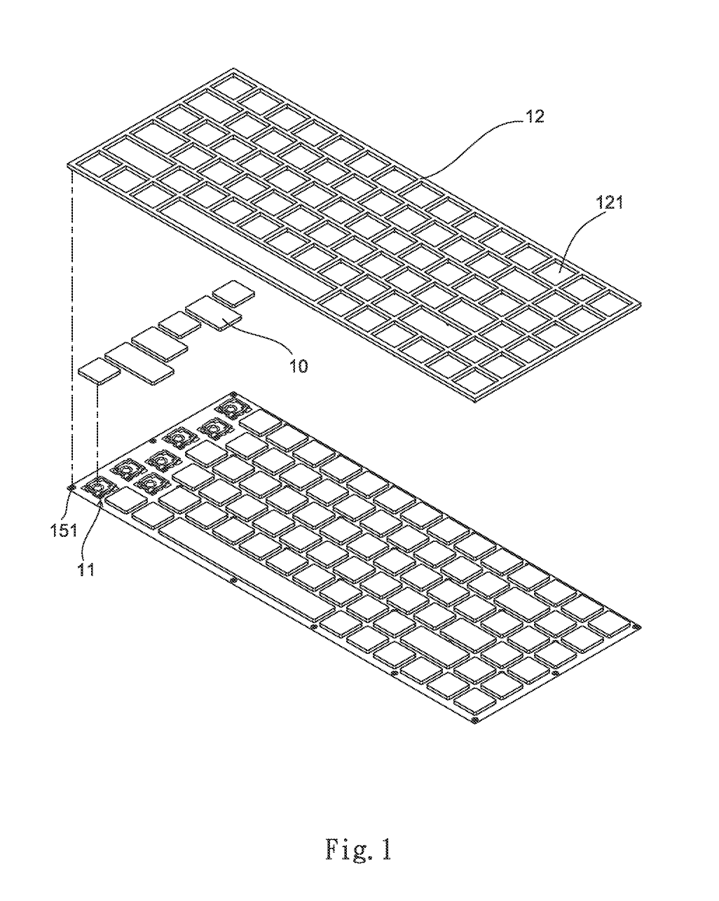

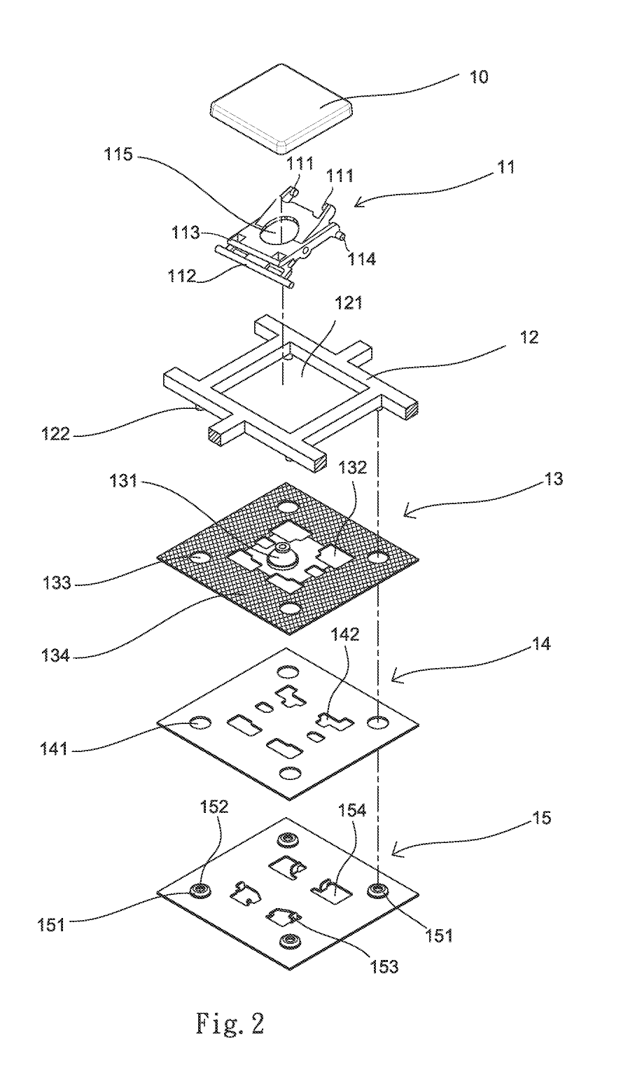

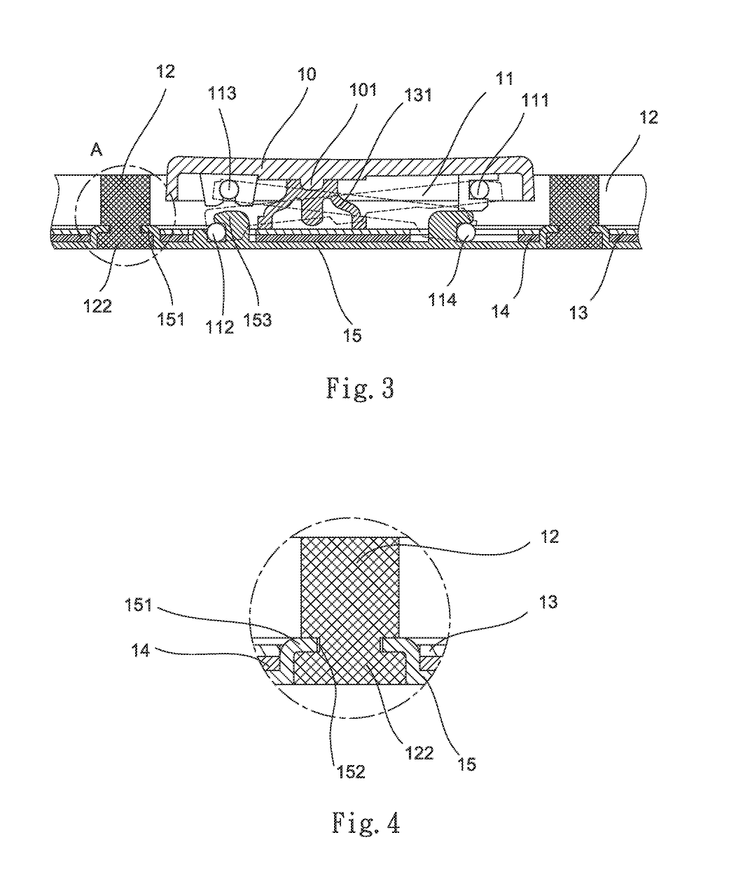

Referring to FIGS. 1 to 4, a membrane keyboard according to a preferred embodiment of the invention is shown. The membrane keyboard is for laptop and comprises the following components, substantially from top to bottom, as discussed in detail below.

A plurality of transparent keys 10 each has a rectangular top surface. On the bottom of the key 10 there are provided a central key shaft 101 extending downward and two pairs of retaining structures (not numbered).

A substantially rectangular key housing 12 is made of plastics and comprises a plurality of rectangular openings 121 with the key 10 disposed therein, and a plurality of downward extending stems 122.

A membrane circuit board 13 is disposed below the key housing 12 and comprises circuitry, a plurality of dome-shaped elastic members 131 formed of a flexible insulative material (e.g., elastomeric material), the elastic member 131 including a central top receptacle (not numbered) for the receipt of the key shaft 101, a plurality of first openings 132 spaced around the elastic member 131, a plurality of second openings 133 spaced around the first openings 132, a plurality of contacts (not shown), and a light blocking layer 134 around the first openings 132.

A plurality of scissor-shaped structures 11 each comprise a central opening 115, two first slide axles 111 at two corners of a first frame (not numbered), two second slide axles 114 at two corners of a second frame (not numbered) pivotally secured to the first frame to have a longitudinal section of “X”, the second slide axles 114 being below the first slide axles 111, a first pivot shaft 113 at the opposite side of the second frame, and a second pivot shaft 112 at the other side of the first frame parallel to and below the first pivot shaft 113. The first slide axles 111 and the first pivot shaft 113 are pivotably secured to the retaining structures on the bottom of the key 10. The elastic member 131 inserts through the central opening 115 so that the scissor-shaped structure 11 can be spaced around the elastic member 131.

A light emitting and guiding plate 14 is transparent and made of silicon rubber. The light emitting and guiding plate 14 is disposed below the membrane circuit board 13 and comprises a plurality of spaced light-emitting diodes (LEDs) (not shown), the LEDs being electrically connected to the circuitry of the membrane circuit board 13, a plurality of first apertures 142 aligned with the first openings 132, and a plurality of second apertures 141 spaced around the first apertures 142 and aligned with the second openings 133. The light emitting and guiding plate 14 functions as a light diffusing and guiding member. In detail, the light emitting and guiding plate 14 can substantially uniformly direct light emitted by the LEDs toward the keys 10 through portions of the membrane circuit board 13 not covered by the light blocking layer 134. Hence, the keys 10 are lit uniformly when the laptop is turned on.

An aluminum plate 15 is disposed below the light emitting and guiding plate 14 and comprises, on a top surface, a plurality of openings 154 aligned with the apertures 142 from below, a plurality of retaining members 153 each projecting upward from an edge of the opening 154, a plurality of bosses 151 spaced around the retaining members 153, and a plurality of holes 152 each disposed in the boss 151. The stems 122 are disposed through the second openings 133, the second apertures 141 and the holes 152 for positioning. The second slide axles 114 and the second pivot shaft 112 are pivotably disposed in and retained by the retaining members 153 after inserting through the first openings 132 and the first apertures 142. Thus, the corresponding key 10, scissor-shaped structure 11, the key housing 12, the membrane circuit board 13, the light emitting and guiding plate 14, and the aluminum plate 15 are positioned substantially from top to bottom. Finally, as the subject of the invention, the positioned stems 122 are subjected to ultrasonic welding to be fastened.

In use, a user may press the key 10 to push down the key shaft 101 to pivot the scissor-shaped structure 11 so that the elastic member 131 can be elastically downward compressed by the key 10. The depression of the elastic member 131 can cause the contacts to engage each other so as to electrically connect them together. As a result, a key switch is “closed” and the depressed key 10 is activated. It is understood that a release of the key 10 will elastically return the key 10 to its rest position.

While the invention has been described in terms of preferred embodiments, those skilled in the art will recognize that the invention can be practiced with modifications within the spirit and scope of the appended claims.

What is claimed is:

1. A membrane keyboard, comprising:
a plurality of transparent keys each comprising a key shaft on a bottom;
a plastic key housing comprising a plurality of rectangular openings each for receipt of the key, and a plurality of downward extending stems;
a membrane circuit board disposed below the key housing and comprising a plurality of dome-shaped elastic members, a plurality of first openings spaced around the elastic member, a plurality of second openings spaced around the first openings, and a light blocking layer spaced around the first openings;
a plurality of scissor-shaped structures each comprising a central opening, two first slide axles, two second slide axles below the first slide axles, a first pivot shaft opposite to the first slide axles, and a second pivot shaft opposite to the second slide axles and below the first pivot shaft wherein the first slide axles and the first pivot shaft of each scissor-shaped structure are pivotably secured to the bottom of the key and the central opening of each scissor-shaped structure is spaced around the elastic member;
a transparent light emitting and guiding plate disposed below the membrane circuit board and electrically connected to the membrane circuit board, the light emitting and guiding plate comprising a plurality of first apertures aligned with the first openings, and a plurality of second apertures spaced around the first apertures and aligned with the second openings; and
an aluminum plate disposed below the light emitting and guiding plate and comprising a plurality of retaining members, a plurality of bosses spaced around the retaining members, and a plurality of holes each disposed in the boss;
wherein the stems are disposed through the second openings, the second apertures, and the holes for positioning;
wherein the second slide axles and the second pivot shaft of each scissor-shaped structure are pivotably disposed in and retained by the retaining members; and
wherein the positioned stems are subjected to ultrasonic welding to be fastened.

2. The membrane keyboard of claim 1, wherein a pressing of the key pushes down the key shaft and pivots the scissor-shaped structure so as to compress the elastic member and the compressed elastic member causes an electrical contact so that a key press is carried out.

3. The membrane keyboard of claim 1, wherein the aluminum plate supports the key housing, the membrane circuit board, and the light emitting and guiding plate.
